(19) United States
(12) Patent Application Publication
(10) Pub. No.: US 2004/0053201 A1
(43) Pub. Date: Mar. 18, 2004

(54) Antibacterial sponges for use in endodontic procedures and methods of use

(76) Inventor: Joseph S. Dovgan, Scottsdale, AZ (US)

Correspondence Address: Rick D. Nydegger, WORKMAN, NYDEGGER & SEELEY, 1000 Eagle Gate Tower, 60 East South Temple, Salt Lake City, UT, 84111, US

(21) Appl. No.: 10/245,085

(22) Filed: Sep. 17, 2002

(51) Int. Cl. A61C 5/02

(52) U.S. Cl. 433/224; 424/49

(57) ABSTRACT

A method for preventing infections during an endodontic procedure comprises removing pulp material from a pulp canal and inserting a temporary antibacterial material, such as a sponge or pellet, into the resulting pulp cavity. The antibacterial material comprises an absorbent material embedded with an antibacterial composition. Optional components that can also be embedded in the antibacterial material include hemostatic agents, colorants, and radiopaque materials. A temporary restoration is applied over the pulp canal and antibacterial material for a desired time period, after which the temporary restoration and antibacterial sponge are removed and a permanent filling is introduced into the root canal and a permanent restoration is attached to the tooth. Because temporary restorations often leak bacteria-laden saliva, the antibacterial sponge prevents infections arising from such bacteria while the temporary restoration is in place.

### BACKGROUND OF THE INVENTION

1. The Field of the Invention

The present invention relates generally to methods and devices for preventing infections in pulp canals following endodontic procedures. In particular, the invention relates to the use of an antibacterial sponge or pellet in a pulp canal space when a temporary restoration in place.

2. The Relevant Technology

When tooth decay or a cracked tooth results in an infected tooth, the pulp (the soft structure of a tooth, consisting of nerves, blood vessels, and connective tissue) often becomes diseased or injured, cannot repair itself, and dies. The disease results from bacteria that enters the pulp, causing an infection inside the tooth. Left without treatment, pus builds up at the root tip in the jawbone, forming a “pus-pocket” called an abscess. An abscess can cause damage to the bone around the teeth and cause pain and swelling. Without treatment, the tooth may have to be removed.

Preserving a tooth with a diseased or potentially diseased pulp generally requires several surgical steps. First, an opening is made through the crown of the tooth into the pulp canal and as much of the pulp material as is possible is removed from the pulp canal(s) of the tooth. Next, the pulp canal(s) is shaped without excessively weakening the pulp canal walls. The presence of bacteria is minimized to avoid infection through the use of irrigants and dressings. Finally, the walls of the pulp canal(s) are cleaned by removing the smear layer created during instrumentation of the pulp canal(s). These steps are all done to form and prepare the pulp cavity for sealing or obturation which involves filling the pulp cavity with biocompatible materials, such as gutta percha, before the pulp cavity is sealed, thereby promoting the healing and functional recovery of the tooth.

U.S. Pat. No. 4,565,722, issued to Highgate et al., discloses another method of filling the pulp cavity, a tapered polymeric dental insert that absorbs fluids in the pulp cavity, expanding to fill the cavity. The polymeric insert is designed so that it expands laterally but not vertically so that it does not dislodge the permanent restoration applied thereover. The polymeric insert can be treated with an antibacterial compound such as formaldehyde.

It is often necessary to apply a temporary filling and seal over a cleansed and hollowed pulp canal so that a patient can be given medicine to eliminate infections that may have spread to deep portions of the pulp canal or beyond the tooth. The use of the temporary restoration allows a dental practitioner to ensure that the infection is eliminated before the final restoration is applied.

When such a temporary filling and seal is used, the pulp cavity is not immediately filled with biocompatible materials. This allows the dental practitioner to examine the pulp cavity. In its place, a removable cotton spacer is typically used to maintain the pulp cavity intact underneath the temporary restoration. The cotton spacer is typically imbedded with a hemostatic composition to control bleeding within the pulp cavity, and thus both controls bleeding and acts as a spacer within the pulp cavity.

After a certain time, the temporary filling and cotton spacer are removed and the pulp chamber and pulp canal(s) are cleaned and filled. Finally, a gold or porcelain crown is usually placed over the tooth.

Throughout the pulp canal therapy process, there is an increased risk of re-infection due to the opened pulp cavity. This risk is particularly accentuated during the time that a temporary filling is applied. This is because, although diseased pulp is removed and antibacterial compositions are used to sterilize the emptied pulp cavity, bacteria can re-enter the pulp canal because temporary restorations do not provide perfect seals against the entry of saliva, which can carry bacteria. Therefore, there is a need for improved methods and devices for effectively avoiding infection during pulp canal therapy.

### SUMMARY OF THE INVENTION

The present invention relates to methods and devices for preventing an infection in a pulp canal(s) during endodontic procedures. Because temporary restorations used during pulp canal procedures often leak saliva into the resulting pulp cavity, and saliva often contains bacteria, infections can arise in the pulp cavity while temporary restorations are in place. Therefore, the present invention relates to the use of an antibacterial material, such as a sponge or pellet, in a pulp cavity when a temporary restoration is in place.

One preferred antibacterial sponge or pellet for preventing pulp canal infections underneath temporary restorations comprises a sponge or pellet with an effective amount of an antibacterial composition absorbed therein. Various preferred antibacterial compositions include chlorhexidine gluconate, hydrogen peroxide, and cetyl pyridinium chloride. An additional non-exclusive list of exemplary antibacterial compositions is provided hereinbelow in the Detailed Description of the Invention section of the application. According to one embodiment, the antibacterial sponge or pellet provides a sustained release of the antibacterial composition.

The sponge or pellet can also include hemostatic agents to control bleeding, colorants so the sponge or pellet can easily be seen and removed by a dental practitioner, and radiographic materials so the sponge or pellet can be identified with radiographic techniques.

The sponge material can comprise various materials, for example a silicon-based material, a plastic material, cellulose, or a naturally occurring sponge. One skilled in the art will recognize that cotton pellets can also be used, although cotton is less preferred.

Methods according to the invention for preventing infections underneath temporary restorations generally involve forming an opening through the crown of a tooth and into a pulp canal, removing pulp material from the pulp canal, thereby forming a pulp cavity, cleansing the pulp cavity, and inserting an antibacterial material as described herein into the exposed pulp canal. A temporary restoration is applied over the pulp canal and antibacterial material. After the prescribed time the temporary restoration and antibacterial material are removed, the pulp cavity is filled and sealed, and a permanent restoration, such as a crown, is applied.

These and other features of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates the use of an antibacterial material in a pulp cavity according to one embodiment of the invention.

FIG. 2 illustrates the use of an antibacterial material in a pulp cavity beneath a temporary restoration according to another embodiment of the invention.

### DETAILED DESCRIPTION OF THE INVENTION

The present invention relates generally to methods for preventing infection in pulp canals following endodontic procedures. In particular, the invention relates to the use of an antibacterial material, such as a sponge or pellet, in a pulp cavity when a temporary restoration in place. Because temporary restorations often leak saliva into the pulp cavity, and saliva contains bacteria, the antibacterial material serves to prevent the bacteria from causing infections in the pulp cavity.

Preferred sponge or pellet materials according to the invention are highly absorbent so they can hold a desired amount of an antibacterial composition in a minimal space. The sponges and pellets are thus preferably smaller than is used with conventional spacers, such as cotton, that are used under temporary restorations. This enables the sponge or pellet to easily be inserted and removed while still providing the desired functions. Generally, the sponge or pellet should be sized and shaped according to the size and shape of the pulp chamber into which they will be inserted. Of course, the sponge or pellet can be compressed during placement such that it can be larger than the hole or void into which it is placed. The antibacterial sponges or pellets according to the invention preferably have a diameter in a range of about 1 mm to about 1.5 cm, more preferably in a range of about 2 mm to about 1 cm, and most preferably in a range of about 3 mm to about 8 mm. Thus, according to one embodiment of the invention preferred sponges and pellets provide a physical and chemical barrier that prevents bacteria from reaching the pulp canal(s).

Sponges are light, fibrous connective structures that have absorbent qualities. They can be made from a variety of different materials, including, but not limited to, silicone, gelatin, porcine gelatin matrix (e.g., Gelfoam), degradable polymers, polyvinyl alcohol, polyethylene (i.e., Skubes dental sponge made by Denmat), polypropylene, collagen (Collocate), cellulose, cellulose acetate (e.g., Kittner roll gauze), other cellulose derivatives, plastics, cotton, and natural sponges. Pellets can be made from essentially the same materials but differ from sponges in being more dense and less flexible.

In one embodiment, it may be desirable to load the pulp cavity with a plurality of pellets or sponges appropriately sized so that they will fit within the pulp cavity in question. In another embodiment, a single sponge or pellet appropriately sized can be used.

Because of the small size of the antibacterial sponges and the often difficult to see colors of the preferred sponges and pellets, it can be difficult for a dental practitioner to locate the sponges or pellets for removal. Accordingly, according to one embodiment of the invention the sponge further comprises a colorant material that has been added to make the sponge contrast with the color of the tooth, thus making the sponge highly visible to a dental practitioner. Such colorant materials may include, for example, red, blue, or green dyes or pigments. Virtually any color could be used to make the pellets and sponges according to the invention more easily seen by the dental practitioner during use.

According to yet another embodiment of the invention the sponge or pellet may include a radiopaque material to enable the detection of the sponge or pellet through radiographic techniques. Such radiopaque materials may include, for example, barium sulfate, silver, silver salts, bismuth salts or other well-known radiopaque materials known in the dental art.

One preferred antibacterial composition for use with the invention is a chlorhexidine gluconate solution. For example, a 2.0% chlorhexidine gluconate solution is commercially available under the trademark Consepsis® from Ultradent Products, Inc. Of course, other concentrations of chlorhexidine gluconate, preferably in a range of about 0.5% to about 10% by weight of the antibacterial composition, more preferably in a range of about 1% to about 6%, and most preferably in a range of about 2% to about 4%.

Another preferred antibacterial composition is a hydrogen peroxide solution in a concentration from about 5% to about 50% by volume of the antibacterial composition, more preferably from about 8% to about 40% by volume, and most preferably about 30% by volume.

Other examples of suitable antibacterial compositions include: 1,1′-hexamethylene bis(5(p-chlorophenyl)biguanide), cetyl pyridinium chloride, benzalkonium chloride, cetyl pyridinium bromide, methyl 4-hydroxybenzoate, propylparaben (propyl p-hydroxybenzoate), sodium hypochlorite, phenol, and combinations and derivatives thereof. The antibacterial agent may be added in any suitable amount, depending upon the strength and safety of the particular antibacterial composition.

It will be appreciated by one skilled in the art that the above examples of antibacterial materials are non-limiting of the invention, and are merely presented to provide examples of suitable antibacterial compositions and concentrations thereof. One skilled in the art will be able, in view of the disclosure herein, to select appropriate antibacterial compositions and concentrations thereof.

According to one embodiment of the invention, the antibacterial material can also hold a hemostatic composition to control bleeding in the pulp cavity. For example, the hemostatic composition can comprise a 15.5% ferric sulfate (Fe₂(SO₄)₃) aqueous composition, available commercially under the trademark Astringedent® from Ultradent Products, Inc. Other examples of compatible hemostatic compositions are ferric subsulfate Fe₄(OH)₂(SO₄)₅, aluminum chloride and alum. Of course, these hemostatic compositions are merely exemplary, and one skilled in the art will recognize, in view of the disclosure herein, that a variety of hemostatic compositions are compatible with the antibacterial sponges of the present invention.

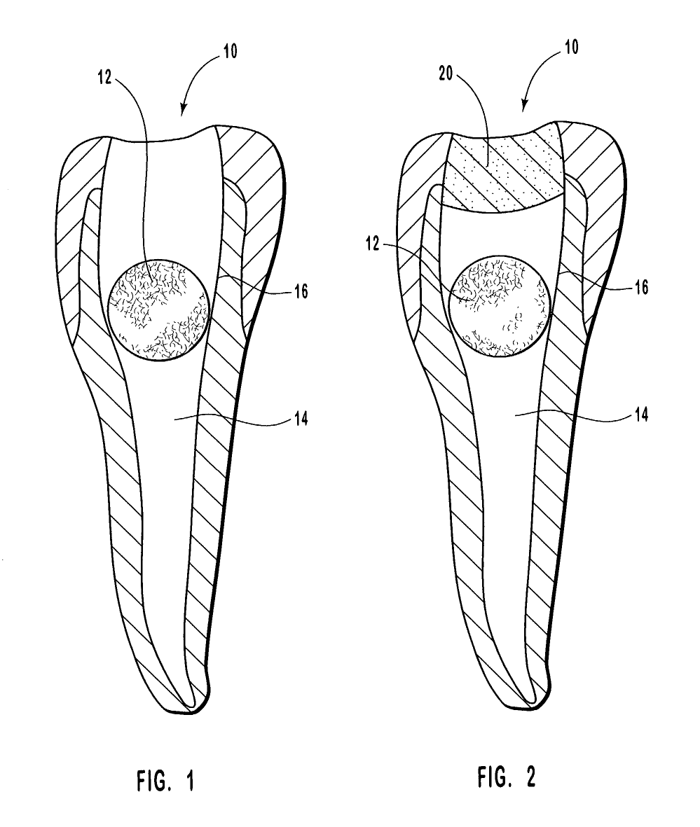

Referring now to the drawings, wherein like structures are provided with like reference designations, the drawings only shows the structures necessary to understand the present invention. One skilled in the art will recognize that the drawings are not drawn to scale or intended to be limiting of the particular type of tooth that can be treated. Accordingly, FIG. 1 depicts a tooth 10, wherein an antibacterial sponge or pellet 12 as described hereinabove has been placed into a pulp cavity 14. As illustrated in FIG. 2, a temporary restoration 20 is applied to provide temporary protection for pulp cavity 14 before a final restoration is applied. Collectively, temporary restoration 20 and antibacterial sponge or pellet 12 provide both chemical and physical barriers to prevent infection in the exposed pulp cavity.

A preferred method according to the invention of using antibacterial sponge or pellet 12 to prevent infections during endodontic procedures is described hereinbelow. First, a local anesthetic is given to maintain patient comfort and the affected tooth is isolated from saliva with a rubberlike sheet called a dam. An opening is made through the crown of the tooth and into the pulp canal, exposing the pulp.

The preparation of pulp cavity 14 is then performed as follows. First, the pulp, the soft tissue found in the pulp canal that runs through the center of the hard tissue on the inside of the tooth, including blood vessels, nerves and connective tissue, is removed. The resulting pulp canal walls 16 of the pulp cavity 14 are then cleansed and irrigated and pulp canal walls 16 are shaped. The cleansing of the pulp canal chamber and walls may involve medication that is added to help eliminate bacteria. This pulp cavity preparation is typically achieved through a guided procedure with the use of one or more endodontic instruments, which are moved manually, mechanically, or by combinations thereof.

An antibacterial sponge or pellet 12 as described hereinabove is then positioned in pulp cavity 14 so as to provide chemical protection to combat microbes that may enter the tooth. Preferably, antibacterial sponge or pellet 12 also forms a physical barrier that protects the root canal(s) from the ingress of microbes.

Also as described hereinabove, antibacterial sponge or pellet 12 can contain hemostatic agents as well as colorants and radiographic materials.

Because, the infection often spreads beyond the end of the root(s) and the portion of the pulp that has been removed from tooth 10, if is often necessary to treat the patient with antibiotics to eliminate the infection. Because it is desirable to keep pulp cavity 14 open for inspection during the antibiotic treatment, a temporary restoration 20 is used during the time that the patient is treated, as illustrated in FIG. 2. The temporary restoration 20 is placed in the crown opening to protect pulp cavity 14 and keep as much bacteria-laden saliva as possible out. However, as described hereinabove, saliva inevitably may leak in causing infection if the appropriate precautions disclosed herein are not undertaken.

Once the infection is eliminated, usually after a few weeks, temporary restoration 20 is removed in preparation for installing a permanent filling, seal, and restoration.

The antibacterial sponge or pellet 12 is also removed at this time.

A metal or plastic rod or post may be placed in the pulp canal for structural support, and the pulp cavity is then filled. One preferred pulp cavity filling material is gutta percha. Gutta percha is available in cone shapes with different sizes and is a natural rubber. The composition of gutta percha includes a thermoplastic resin matrix, zinc oxide as a filler, one or more barium- or strontium-containing compounds as a filler and radiopacifier, waxes or resins, pigments, and plasticizers. Of course, other conventional filling materials are also suitable, such as flowable composite resins, with or without the use of gutta percha, as described in U.S. patent application Ser. No. 09/736,729, filed Dec. 14, 2000.

A seal is then applied over the filling material. One preferred seal comprises a two-paste system containing zinc oxide and eugenol that is commercially available under the trademark EndoSeal™ from Ultradent Products, Inc.

Finally, a permanent restoration, such as a crown, is applied as the final layer over the tooth. Crowns are made from a variety of materials, depending on the location of the tooth, the color of the tooth, and the amount of natural tooth remaining. Traditional crown materials include gold and porcelain, although newer crown materials are constantly being developed to provide longer life and more closely match the color of the teeth.

The following examples are given to illustrate the present invention, and are not intended to limit the scope of the invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for preventing infections following an endodontic procedure, comprising:
exposing at least one root canal of a tooth; and
inserting an antibacterial material into the exposed root canal, the antibacterial material comprising:
an absorbent material selected from the group consisting of a sponge and a pellet; and
an effective amount of an antibacterial composition.

2. The method of claim 1, further comprising applying a temporary restorative onto the tooth with the antibacterial material remaining within the root canal.

3. The method of claim 1, wherein the antibacterial composition comprises chlorhexidine gluconate.

4. The method of claim 3, wherein the chlorhexidine gluconate has a concentration in a range of about 0.5% to about 10% by weight in the antibacterial composition.

5. The method of claim 3, wherein the chlorhexidine gluconate has a concentration in a range of about 1% to about 6% by weight in the antibacterial composition.

6. The method of claim 3, wherein the chlorhexidine gluconate has a concentration in a range of about 2% to about 4% by weight of the antibacterial composition.

7. The method of claim 1, wherein the antibacterial composition comprises hydrogen peroxide.

8. The method of claim 7, wherein the hydrogen peroxide has a concentration in a range of 5% to about 50% by volume of the antibacterial composition.

9. The method of claim 7, wherein the hydrogen peroxide has a concentration in a range of 8% to about 40% by volume of the antibacterial composition.

10. The method of claim 7, wherein the hydrogen peroxide has a concentration of about 30% by volume of the antibacterial composition.

11. The method of claim 1, wherein the antibacterial composition comprises at least one member selected from the group consisting of 1,1′-hexamethylene bis(5(p-chlorophenyl)biguanide), cetyl pyridinium chloride, benzalkonium chloride, cetyl pyridinium bromide, methyl 4-hydroxybenzoate, propylparaben (propyl p-hydroxybenzoate), sodium hypochlorite, phenol, and combinations and derivatives thereof.

12. The method of claim 1, wherein the sponge or pellet comprises a silicon-based material.

13. The method of claim 1, wherein the sponge or pellet comprises at least one material selected from the group consisting of gelatine, porcine gelatin matrix, degradable polymers, polyvinyl alcohol, polyethylene, polypropylene, collagen, cellulose, cellulose acetate, other cellulose derivatives, plastics, cotton and natural sponges.

14. The method of claim 1, wherein the sponge or pellet further comprises a hemostatic agent.

15. The method of claim 1, wherein the sponge or pellet further comprises a colorant to more clearly distinguish the sponge from the tooth.

16. The method of claim 1, wherein the sponge or pellet further comprises a radiopaque material.

17. A method for preventing infections following an endodontic procedure, comprising:
forming an opening through the crown of a tooth and into a pulp canal of the tooth;
removing pulp material from the pulp canal, thereby forming a pulp cavity;
inserting at least one antibacterial sponge or pellet into the pulp cavity, the antibacterial sponge or pellet having an antibacterial composition absorbed therein;
applying a temporary restoration over the pulp canal containing the antibacterial sponge or pellet and leaving it in place for a desired period of time;
after the desired period of time, removing the temporary restoration and antibacterial sponge or pellet;
introducing at least one of a filling or sealing material into the pulp cavity; and
applying a permanent restoration onto the tooth.

18. The method of claim 17, wherein the antibacterial composition comprises at least one of chlorhexidine gluconate or hydrogen peroxide.

19. The method of claim 17, wherein the antibacterial composition comprises a at least one member selected from the group consisting of 1,1′-hexamethylene bis(5(p-chlorophenyl)biguanide), cetyl pyridinium chloride, benzalkonium chloride, cetyl pyridinium bromide, methyl 4-hydroxybenzoate, propylparaben (propyl p-hydroxybenzoate), sodium hypochlorite, phenol, and combinations and derivatives thereof.

20. The method of claim 17, wherein the antibacterial sponge or pellet further comprises at least one of a colorant or hemostatic agent.

21. The method of claim 17, wherein the antibacterial sponge or pellet is formed from a silicon-based material.

22. An antibacterial device for use in disinfecting a pulp canal following an endodontic procedure, comprising:
an absorbent material comprising a pellet or sponge and sized and shaped for temporary insertion into an exposed and cleaned root canal of a tooth; and
an effective amount of an antibacterial composition absorbed into the absorbent material;
wherein the antibacterial device provides a sustained release of the antibacterial composition when in use.

23. The antibacterial device of claim 22, further comprising a colorant.

24. The antibacterial device of claim 22, further comprising a radiopaque material.

25. The antibacterial device of claim 22, further comprising a hemostatic agent.

26. The antibacterial device of claim 22, wherein the antibacterial composition comprises at least one of chlorhexidine gluconate or hydrogen peroxide.

27. The antibacterial device of claim 22, wherein the antibacterial composition comprises at least one of sodium hypochlorite, 1,1′-hexamethylene bis(5(p-chlorophenyl)biguanide), cetyl pyridinium chloride, benzalkonium chloride, cetyl pyridinium bromide, methyl 4-hydroxybenzoate, propylparaben (propyl p-hydroxybenzoate), sodium hypochlorite, or phenol.

28. The antibacterial device of claim 22, wherein the absorbent material comprises a silicon-based sponge.
